(19) United States
(12) Patent Application Publication
(10) Pub. No.: US 2021/0409962 A1
(43) Pub. Date: Dec. 30, 2021

(54) FLOW CONTROLLER RESOURCE ALLOCATION

(71) Applicant: T-Mobile USA, Inc., Bellevue, WA (US)

(72) Inventors: Ming Shan Kwok, Seattle, WA (US); Wafik Abdel Shahid, Kenmore, WA (US); Alejandro Aguirre-Rivadeneyra, Sammamish, WA (US); Hsin-Fu Henry Chiang, Bellevue, WA (US)

(73) Assignee: T-Mobile USA, Inc.

(21) Appl. No.: 16/914,216

(22) Filed: Jun. 26, 2020

(51) Int. Cl. H04W 16/14; H04W 72/04; H04W 28/02; G06N 20/00; G06K 9/62; H04W 80/02

(52) U.S. Cl. CPC H04W 16/14; H04W 72/0453; H04W 80/02; G06N 20/00; G06K 9/6256; H04W 28/0268

(57) ABSTRACT

A flow controller executing at a network element of a telecommunication network can dynamically allocate portions of spectrum to use for different types of network traffic and/or different user equipments (UEs). For example, the flow controller can use packet characteristics, UE characteristics, and/or network characteristics to determine a state of the telecommunication network. Based on the state of the telecommunication network, the flow controller can determine that certain portions of spectrum should be used to transport certain traffic, and in turn cause base stations to use those portions of spectrum for corresponding connections with one or more UEs. The allocated portions of spectrum can include frequencies in low band spectrum, mid-band spectrum, and/or high band spectrum.

### BACKGROUND

A radio access network (RAN) of a telecommunication network can use frequencies in multiple spectrum ranges to connect with user equipment (UE). For example, the RAN may communicate with UEs using low band frequencies under 1 GHz, mid-band frequencies between 1 GHz and 6 GHz, and/or high band frequencies above 6 GHz, including millimeter wave (mmW) frequencies above 24 GHz.

Different frequencies may have different attributes and/or cover different geographical areas. For example, signals sent via low band frequencies often propagate over larger distances than signals sent via mid-band frequencies or high band frequencies. However, different frequencies may be associated with different latency metrics, different throughput metrics, and/or other metrics.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example network environment in which a UE can connect to a telecommunication network, and a flow controller can determine portions of spectrum to use for the connection with the UE.

FIG. 2 shows an example of differing geographical ranges associated with different spectrum bands.

FIG. 3 shows an example network environment in which the flow controller can be executed outside a base station.

FIG. 4 shows an example table of input factors that the flow controller can use to determine portions of spectrum to use to transmit data packets.

FIG. 5 shows an example of a machine learning system that can generate a spectrum allocation configuration for the flow controller.

FIG. 6 shows an example of data packets passing through protocol layers.

FIG. 7 shows a first example table of traffic types that correspond to spectrum ranges.

FIG. 8 shows an example in which a RAN is connected to multiple UEs.

FIG. 9 shows a second example table of traffic types that correspond to spectrum ranges.

FIG. 10 shows an example system architecture for a network element configured to execute the flow controller.

FIG. 11 shows a flowchart of an example method that a flow controller can use to determine a spectrum allocation based on input factors associated with a state of the RAN.

### DETAILED DESCRIPTION

### Introduction

A telecommunication network can include base stations in one or more Radio Access Networks (RANs). The base stations can use one or more radio access technology (RAT) types, such as Long-Term Evolution (LTE) or fifth generation New Radio (5G NR). For example, a base station that uses LTE can be an evolved Node B (eNB). As another example, a base station that uses 5G NR can be a gNB. User equipment (UE) can wirelessly connect to base stations to send and/or receive data. In some examples or situations, a UE can connect to a single base station. However, in other examples or situations, a UE may simultaneously connect to multiple base stations. For instance, a UE may connect to both an eNB and a gNB via an E-UTRAN New Radio—Dual Connectivity (EN-DC) connection.

Base stations and/or UEs may support data transmissions at frequencies in one or more spectrum bands. For example, data transmissions may occur at frequencies in the licensed spectrum, including low band frequencies under 1 GHz, mid-band frequencies between 1 GHz and 6 GHz, and high band frequencies above 6 GHz, including mmW frequencies above 24 GHz. In some examples, data transmissions may also occur at frequencies in the unlicensed spectrum, such as frequencies associated with the Citizens Band Radio Service (CBRS) spectrum or frequencies associated with Wi-Fi protocols. Generally, base stations and/or UEs can use any supported frequencies to establish connections and transmit data. However, allowing base stations and/or UEs to use any supported frequency can impact network traffic in several ways.

As an example, although individual base stations may have low-level schedulers that can determine which frequencies to use to transmit data to UEs, such schedulers often select any available frequency for UEs without respect to different traffic types and/or different UE types. Accordingly, even if network traffic is associated with a low-latency service, such schedulers may select a frequency to transmit the network traffic based on the frequency being available, and not with regard to a latency associated with that frequency. Such schedulers may also be specific to individual base stations, and generally do not consider a state of the network with respect to neighboring base stations, current usage of frequencies in the surrounding area, historical and/or predicted patterns of frequency usage, attributes of different services and UEs, and/or other factors.

As another example, if a fire or other emergency occurs at a location, first responders may use UEs to communicate via the telecommunication network. Conventional schedulers at base stations may assign any available frequency to the first responder UEs, even though low band spectrum may in some cases provide the most reliable communications and/or the widest coverage area and thus may allow the first responders to communicate more reliably. For instance, if numerous UEs in the area are already using the low band spectrum, there may not be sufficient network capacity for the first responder UEs in the low band spectrum, and the base stations schedulers may instead select mid-band frequencies for the first responder UEs. Such mid-band frequencies may be more abundant and thus have more capacity, but may have smaller coverage areas and/or be less reliable than low band frequencies and thereby negatively impact transmission of emergency traffic to and from the first responder UEs.

As yet another example, certain types of network traffic may be considered guaranteed bitrate (GBR) traffic. However, in some situations, network resources may not be available to transport that traffic at guaranteed bitrates. For example, a UE may be located at a position near a cell edge that is only served by low band frequencies. If the low band is already in heavy use, there may not be enough low band frequencies available to establish bearers for GBR traffic for the UE at the cell edge, and conventional systems may need to deny requests to transport such traffic at guaranteed bitrates and instead use best-effort transmissions to transport such traffic. This can lead to negative user experiences, as traffic that is intended to be GBR traffic may be delivered at less than guaranteed bitrates. In other cases, bearers for GBR traffic can be established, but the network may over-allocate resources to the GBR bearers and leave less spectrum available for non-GBR traffic.

The systems and methods described herein can be used to dynamically allocate one or more portions of spectrum in a telecommunication network with respect to certain types of network traffic and/or types of UEs. Accordingly, connections between UEs and base stations can use frequencies in specific allocated portions of spectrum to transport corresponding types of traffic. The spectrum allocations can be based on input factors, such as packet characteristics of data packets transported through a telecommunication network, UE characteristics of UEs connected to the telecommunication network, and network characteristics including current and/or historical network metrics.

### Example Environment

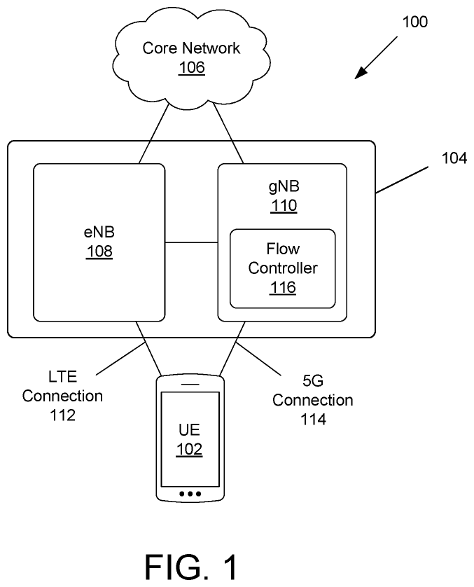

FIG. 1 shows an example network environment 100 in which a UE 102 can connect to a telecommunication network to engage in communication sessions for voice calls, video calls, messaging, data transfers, and/or any other type of communication. The UE 102 can be any device that can wirelessly connect to the telecommunication network. In some examples, the UE 102 can be a mobile phone, such as a smart phone or other cellular phone. In other examples, the UE 102 can be a personal digital assistant (PDA), a media player, a tablet computer, a gaming device, a smart watch, a hotspot, a personal computer (PC) such as a laptop, desktop, or workstation, or any other type of computing or communication device.

The telecommunication network can have a radio access network (RAN) 104 that include base stations and/or other access points, as well as a core network 106 linked to the RAN 104. The UE 102, the RAN 104, and/or the core network 106 can be compatible with one or more radio access technologies, wireless access technologies, protocols, and/or standards, such as 5G NR technology, LTE/LTE Advanced technology, other fourth generation (4G) technology, High-Speed Data Packet Access (HSDPA)/Evolved High-Speed Packet Access (HSPA+) technology, Universal Mobile Telecommunications System (UMTS) technology, Code Division Multiple Access (CDMA) technology, Global System for Mobile Communications (GSM) technology, WiMax® technology, WiFi® technology, and/or any other previous or future generation of radio access technology.

The UE 102 can wirelessly connect to one or more base stations or other access points of the RAN 104, and in turn be connected to the core network 106 via the base stations or other access points. In some examples, the core network 106 can be a packet core network of an LTE network, which may be referred to as an Evolved Packet Core (EPC). In other examples, the core network 106 can be a 5G core network. The RAN 104 can include an LTE access network known as an Evolved UMTS Terrestrial Radio Access Network (E-UTRAN). Base stations of the LTE access network can be known as eNBs, such as the eNB 108 shown in FIG. 1. The RAN 104 can also, or alternately, include 5G access networks with base stations known as gNBs, such as the gNB 110 shown in FIG. 1. In various examples, the RAN 104 can include eNBs, gNBs, a mix of eNBs and gNBs, and/or other base stations or access points. In some examples, the eNB 108 and the gNB 110 shown in FIG. 1 may be located at the same cell site. In other examples, the eNB 108 and the gNB 110 shown in FIG. 1 may be located at different cell sites.

At least one base station in the RAN 104 may be connected to the core network 106. For example, one or both of the eNB 108 and the gNB 110 shown in FIG. 1 may be connected to the core network 106 via S1 interfaces, or other interfaces, for transmission of user plane data and/or control plane data. Some base stations in the RAN 104 may also be connected to each other. For example, the eNB 108 and the gNB 110 shown in FIG. 1 may be connected to each other over an X2 interface, or other interface, for transmission of user plane data and/or control plane data.

The UE 102 can establish an LTE connection 112 with the eNB 108. The UE 102 can also establish a 5G connection 114 with the gNB 110. In some examples, the UE 102 and the telecommunication network can be configured to support dual connectivity between the UE 102 and multiple base stations in the RAN 104. For example, the UE 102 can simultaneously establish the LTE connection 112 with the eNB 108 and the 5G connection 114 with the gNB 110. The UE 102 can thus establish an EN-DC connection with the telecommunication network that uses both the LTE connection 112 and the 5G connection 114.

An EN-DC connection that uses both the LTE connection 112 and the 5G connection 114 may be based on a 3GPP EN-DC configuration, such as an “option 3x” EN-DC configuration, “option 3” EN-DC configuration, “option 3a” EN-DC configuration, or other EN-DC configuration. In some of these examples, the eNB 108 can be a master node in the EN-DC configuration, while the gNB 110 can be a secondary node. In other examples, the gNB 110 can be the master node and the eNB 108 can be the secondary node. The master node may be configured to exchange control plane data with the core network 106, the UE 102, and with the secondary node. In some examples, the secondary node may not have direct interfaces for exchanging control plane data with the core network 106 and/or the UE 102, but may send and receive control plane data via the master node. In some examples, both the eNB 108 and the gNB 110 may be configured to directly exchange user plane data with the core network 106. In other examples, one of the eNB 108 and the gNB 110 may instead indirectly exchange user plane data with the core network 106 via the other one of the eNB 108 and the gNB 110.

When the UE 102 connects to the telecommunication network, one or more bearers can be established between the core network 106 and the UE 102. Bearers can be virtual channels used to transport data for the UE 102 between network elements. For example, an E-UTRAN Radio Access Bearer (E-RAB) can be established between a gateway of the core network 106 and the UE 102, with the E-RAB including an S1 bearer between the gateway of the core network 106 and the eNB 108 and a data radio bearer between the eNB 108 and the UE 102. The LTE connection 112 can thus be associated with the data radio bearer between the eNB 108 and the UE 102. The 5G connection 114 can similarly be associated with a data radio bearer between the gNB 110 and the UE 102.

Multiple bearers can be set up between the network elements for different types of traffic for the UE 102. For example, the telecommunication network can set up a default bearer for general traffic associated with the UE 102, as well as dedicated bearers for traffic associated with specific services. For instance, a dedicated bearer can be set up for voice call data when the UE 102 is engaged in a voice call.

In some examples, a bearer between the core network 106 and the UE 102 can be established as a split bearer that passes through both the eNB 108 and the gNB 110 when an EN-DC connection has been established for the UE 102. The split bearer can include a bearer that splits into an LTE leg associated with the LTE connection 112 between the UE 102 and the eNB 108, and into a 5G leg associated with the 5G connection 114 between the UE 102 and the gNB 110.

Base stations in the RAN 104, such as the eNB 108 and/or the gNB 110 shown in FIG. 1, may be configured to use frequencies in multiple bands of a spectrum to communicate with the UE 102. In some examples, such bands can include low band frequencies under 1 GHz, mid-band frequencies between 1 GHz and 6 GHz, and/or high band frequencies above 6 GHz, including mmW frequencies above 24 GHz. In other examples, low band, mid-band, and/or high band frequencies may include other frequency ranges.

The LTE connection 112 and/or the 5G connection 114 can be associated with one or more specific frequencies supported by the UE 102 and the base stations of the RAN 104. For example, the LTE connection 112 or the 5G connection 114 for the UE 102 can be associated with one or more channels centered at specific frequencies and having bandwidths of 5 MHz, 10 MHz, 15 MHz, 20 MHz, or any other bandwidth. In some examples, carrier aggregation (CA) can be used to assign multiple channels to the UE 102, with each channel being associated with a different component carrier. The component carriers can be at contiguous frequencies in the same band, at non-continuous frequencies in the same band, or at non-contiguous frequencies in different bands. Accordingly, the LTE connection 112 and/or the 5G connection 114 can use channels at one or more assigned frequencies.

In some examples, the RAN 104 can share spectrum between traffic types and/or UEs 102 using Time Division Duplexing (TDD), for instance using Multimedia Broadcast Multicast Service Single Frequency Network (MBSFN) subframes. In other examples, the RAN 104 can share spectrum between traffic types and/or UEs 102 using Frequency Division Duplexing (FDD) techniques and/or using network slices.

LTE spectrum used by the eNB 108 can include low bands and/or mid-bands. For example, the eNB 108 may use one or more of the bands shown below in Table 1, and/or other bands.

TABLE 1
Example Bands in LTE Spectrum

| | Shorthand | Uplink Band | Downlink Band |
|---|---|---|---|
| Band | Frequency (MHz) | (MHz) | (MHz) |
| B2 (Mid-Band) | 1900 | 1850-1910 | 1930-1990 |
| B12 (Low Band) | 700 | 699-716 | 729-746 |
| B25 (Mid-Band) | 1900 | 1850-1915 | 1930-1995 |
| B41 (Mid-Band) | 2500 | 2496-2690 | 2496-2690 |
| B66 (Mid-Band) | 1700 | 1710-1780 | 2110-2200 |
| B71 (Low Band) | 600 | 663-698 | 617-652 |

5G NR spectrum used by the gNB 110 can include similar low bands and mid-bands, as well as bands at higher frequencies such as mmW bands. For example, the gNB 110 may use one or more of the bands shown below in Table 2, and/or other bands.

TABLE 2
Example Bands in 5G NR Spectrum

| | Shorthand | Uplink Band | Downlink Band |
|---|---|---|---|
| Band | Frequency (MHz) | (MHz) | (MHz) |
| n2 (Mid-Band) | 1900 | 1850-1910 | 1930-1990 |
| n12 (Low Band) | 700 | 699-716 | 729-746 |
| n25 (Mid-Band) | 1900 | 1850-1915 | 1930-1995 |
| n41 (Mid-Band) | 2500 | 2496-2690 | 2496-2690 |
| n66 (Mid-Band) | 1700 | 1710-1780 | 2110-2200 |
| n71 (Low-Band) | 600 | 663-698 | 617-652 |
| n260 (mmW) | 39000 (39 GHz) | 37000-40000 | 37000-40000 |
| n261 (mmW) | 28000 (28 GHz) | 27500-28350 | 27500-28350 |

In addition to bands of the licensed spectrum, such as LTE spectrum and/or 5G NR spectrum, in some examples the RAN 104 may be configured to use unlicensed spectrum to communicate with UEs 102. For example, in some circumstances the RAN 104 may have the option of using frequencies associated with the Citizens Band Radio Service (CBRS) spectrum or frequencies associated with Wi-Fi protocols to communicate with UEs 102. For example, in some situations the telecommunication network can bid on at least temporary use of CBRS spectrum to relieve network congestion.

As described herein, a flow controller 116 associated with the RAN 104 can dynamically determine which portions of available spectrum the RAN 104 uses for one or more types of traffic and/or for one or more UEs 102. In some examples, the flow controller 116 can execute at a Packet Data Convergence Protocol (PDCP) layer of a base station or other network element, such that the flow controller can analyze data packets passing through the PDCP layer to determine which portions of spectrum base stations should assign to corresponding connections with UEs 102.

For example, the flow controller 116 may determine that a particular portion of spectrum should be used for a particular type of network traffic, and push other types of traffic to other portions of spectrum. The flow controller 116 can be configured to dynamically determine the portions of spectrum to use in real-time, or near real-time, as data packets are transmitted through the RAN 104. The flow controller 116 can use packet characteristics, network characteristics, UE characteristics, and/or other input factors to determine which portions of spectrum to allocate or reserve for network traffic during corresponding situations. In some examples, machine learning can be used to determine which packet characteristics, network characteristics, UE characteristics, and/or other input factors correspond to certain portions of spectrum that can be reserved or allocated by the flow controller 116.

The flow controller 116 can accordingly allocate portions of spectrum to certain types of network traffic and/or certain UEs 102. In some examples, the flow controller can dynamically allocate spectrum to traffic types and/or UEs, based on a current state of the network. For instance, the flow controller 116 can cause the RAN 104 to, in a particular geographical area, shift some types of traffic to a first portion of spectrum and shift other types of traffic to a different portion of spectrum. As another example, the flow controller 116 may determine that spectrum available in a particular area is insufficient to transport current network traffic, and may allocate portions of CBRS or other unlicensed spectrum to transport at least some of the current network traffic. For instance, the flow controller 116 may cause the telecommunication to bid on CBRS frequencies to ease network congestion.

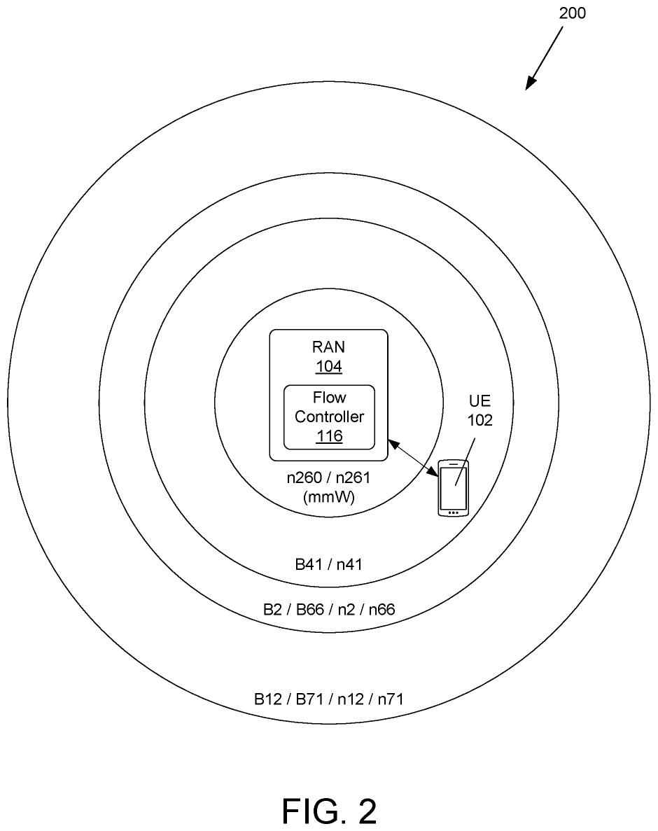

FIG. 2 shows an example 200 of differing geographical ranges associated with different spectrum bands. Different spectrum bands may have different attributes and/or cover different geographical areas. For example, as shown in FIG. 2, in some situations low bands may cover the largest geographical areas, mid-bands may cover smaller geographical areas than the low bands, and mmW bands and other high bands may cover smaller geographical areas than the low bands and/or mid-bands. Additionally, different frequencies may be associated with different metrics, such as latency, throughput, congestion, and/or other metrics. For example, in some situations mmW bands may be capable of providing higher throughput and/or lower latencies than mid-bands or low bands. As another example, low band frequencies may propagate farther and/or have better penetration than higher frequencies, such that the low band can be more reliable than mid-bands or high bands in some cases. As described herein, the flow controller 116 can dynamically allocate portions of these and/or other spectrum bands with respect to different UEs 102 and/or different types of traffic.

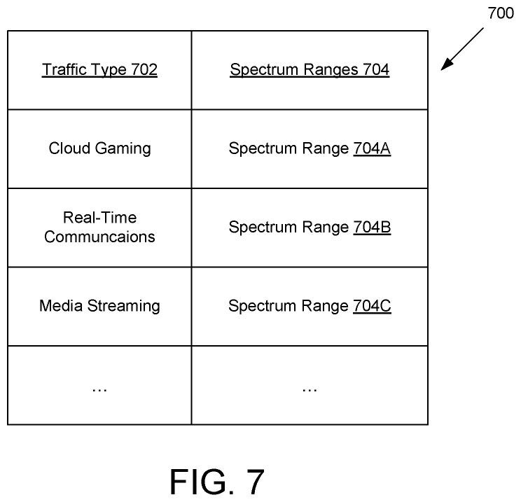

As an example, the flow controller 116 may at least temporarily allocate a portion of low band spectrum for a particular type of traffic, and cause one or more base stations in the RAN 104 to use frequencies in the allocated portion of low band spectrum to transmit the particular type of traffic. In this example, the flow controller 116 can also cause the base stations to transmit other types of traffic using frequencies in other portions of spectrum. Accordingly, the flow controller 116 can reserve the allocated portion of low band spectrum for the particular type of traffic, and cause other types of traffic to be pushed to other portions of spectrum. Other examples of the flow controller 116 allocating spectrum for different UEs 102 and/or different types of traffic are discussed in more detail below with respect to FIGS. 7-9.

In some examples, the flow controller 116 can also cause the telecommunication network to bid on CBRS spectrum, or other unlicensed spectrum, for at least temporary use. For instance, the flow controller 116 may determine that available licensed spectrum is insufficient to transport current network traffic in an area, and thus cause the telecommunication network to at least temporarily obtain access to unlicensed spectrum. If the use of such unlicensed spectrum is obtained, the flow controller 116 can allocate portions of such unlicensed spectrum to certain types of traffic and/or UEs 102 as described herein.

In some examples, the flow controller 116 can execute at a base station in the RAN 104, such as in the eNB 108 or the gNB 110, as shown in FIG. 1. For example, the flow controller 116 can analyze data packets passing through the base station to determine a traffic type associated with the data packets, determine a portion of spectrum that corresponds to the traffic type, and cause the base station and/or other base stations to use the determined portion of spectrum to transmit the data packets to the UE 102.

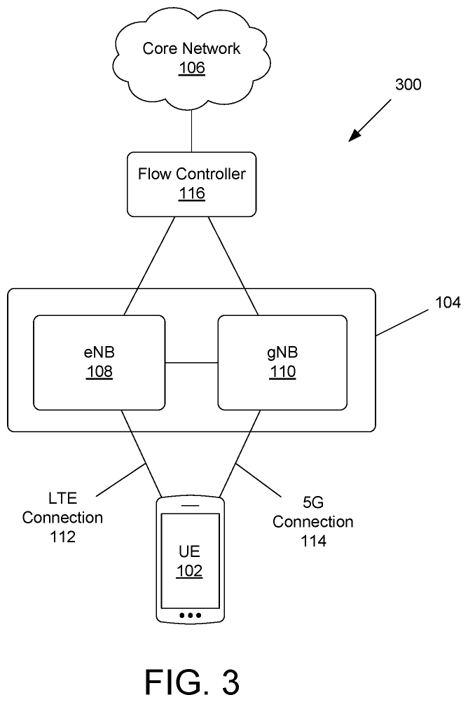

In other examples, the flow controller 116 can execute at another network element, outside a base station. For example, FIG. 3 shows an example network environment 300 in which the flow controller 116 can be executed at a network element positioned between the core network 106 and the RAN 104. The core network 106 can have software and/or hardware elements, such as gateways, routers, and other nodes, that can route data packets from the core network 106 to base stations such as the eNB 108 and the gNB 110. Such data packets may pass through one or more intermediate network elements, such as a base station hotel, a neural host location, a mobile switching office, or other network element. In some cases, such network elements can execute PDCP layer functions and/or other higher layer RAN functions instead of, or in addition to, base stations in the RAN 104. Accordingly, as shown in FIG. 3, in some examples the flow controller 116 can execute at a network element that processes and/or routes data packets between the core network 106 and base stations of the RAN 104.

In these examples, the flow controller 116 between the base stations and the core network 106 can analyze data packets and determine corresponding portions of spectrum for traffic types associated with the data packets. The flow controller 116 can transmit the data packets to one or more base stations, such as the eNB 108 or gNB 110, along with instructions indicating the determined portions of spectrum the base stations are to use when transmitting the data packets to the UE 102. For example, the flow controller 116 may instruct the gNB 110 to use a certain portion of spectrum to transmit one or more data packets to the UE 102 via the 5G connection 114.

In some examples, one or more elements of the telecommunication network can execute a virtual RAN in which processing functions otherwise performed at the eNB 108 and/or the gNB 110 can be executed in virtual machines on servers or other centralized computing elements. In these examples, the flow controller 116 may be executed as part of a virtual RAN. The flow controller 116 in the virtual RAN can also determine portions of spectrum to use for certain types of traffic, and can instruct base station hardware to use the determined portions of spectrum to transmit the data packets to the UE 102.

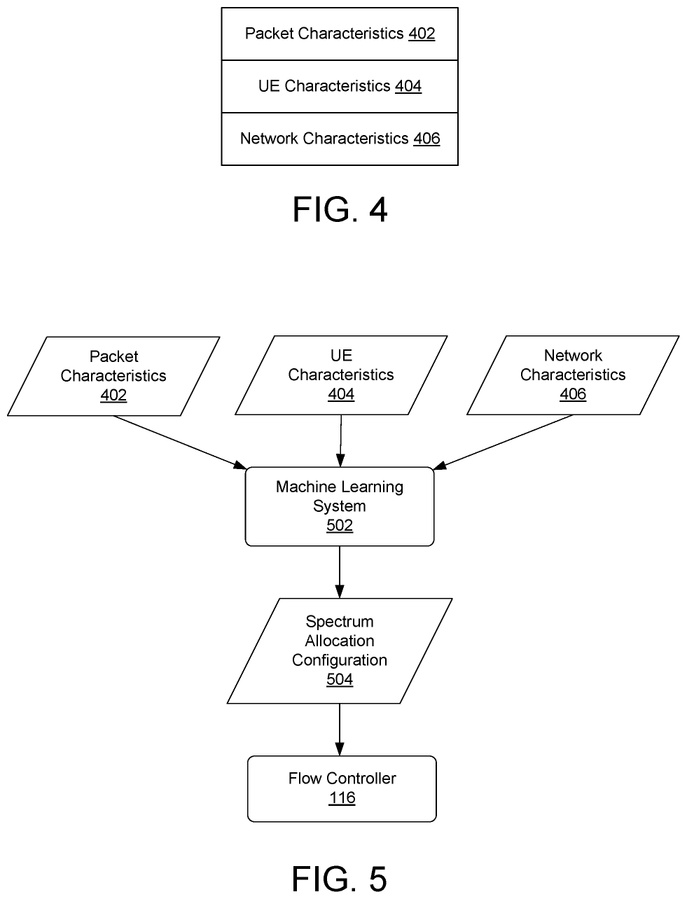

FIG. 4 shows an example table of input factors 400 that the flow controller 116 can use to determine portions of spectrum to use to transmit data packets. For example, the flow controller 116 can use input factors 400 such as packet characteristics 402, UE characteristics 404, network characteristics 406, and/or other data to determine portions of spectrum to use to transmit data packets.

The flow controller 116, executing at base station as shown in FIG. 1 or outside a base station as shown in FIG. 3, can analyze data packets to determine packet characteristics 402 of the data packets. Packet characteristics 402 can be attributes of the data packet that can indicate a traffic type of the data packet, an application or application type associated with the data packet, a service or service type associated with the data packet, or any other information about the data packets.

In some examples, packet characteristics 402 of a data packet can include a Differentiated Services Code Point (DSCP) marking associated with the data packet. A DSCP marking can be a header value, such as a field in an Internet Protocol (IP) header, that indicates whether the data packet is a best effort packet, a high priority packet, or other type or class of packet. For example, a data packet for a real-time voice call can have a DSCP marking indicating that the data packet is a high priority packet, while another data packet for a web browsing session can have a different DSCP marking indicating that the data packet is a best effort packet. In some examples, different DSCP values can be provided that uniquely identify data packets as being telephony packets, real-time interactive packets, multimedia streaming packets, high-throughput data packets, low-priority data packets, and/or other types or classes of data packets.

In some examples, packet characteristics 402 of a data packet can include a Quality of Service (QoS) Class Indicator (QCI) value associated with the data packet or a corresponding bearer. For example, the QCI value may indicate a priority level associated with the data packet, whether the data packet is targeted for transmission at a guaranteed bit rate (GBR) or at a non-GBR, a packet delay budget associated with the data packet, and/or a packet error loss rate associated with the data packet. In some examples, QCI values 1 through 4 can be associated with GBR traffic, with QCI value 1 signifying conversational voice traffic. QoS value 2 signifying conversational video (live streaming) traffic, QoS value 3 signifying traffic such as real-time gaming traffic, and QoS value 4 signifying non-conversational video (buffered streaming). Additionally, in some examples, QCI values 5 through 9 can be associated with non-GBR best-effort traffic, with QCI value 5 signifying IP Multimedia Subsystem (IMS) signaling, QCI values 6, 8, and 9 signifying buffered streaming video and TCP-based file transfers, and QCI value 7 signifying non-GBR voice, live streaming video, and interactive gaming. In some examples, the flow controller 116 can determine the QCI value associated with the data packet based on the QCI value of a bearer that has been established to transport the data packet. In other examples, the flow controller 116 can determine a QCI value associated with the data packet based on header information or other data encoded in the data packet.

In some examples, packet characteristics 402 of a data packet may also, or alternately be indicated in a Service Data Adaptation Protocol (SDAP) header of the data packet. For example, in 5G communications, an SDAP layer at an element of the core network 106 or in the gNB 110 may have added an SDAP header data to a data packet that contains QoS information about the data packet, such as a QoS flow identifier used to identify data packets associated with the same QoS flow.

In some examples, packet characteristics 402 of a data packet may also, or alternately, include other header information, such as source IP address, optional header field, or other data. For example, an optional header field may include information that identifies an application name or application type associated with the data packet. As another example, packet characteristics 402 of a data packet may also indicate one or more identifiers associated with the UE 102, such as a Mobile Station International Subscriber Directory Number (MSISDN) of the UE 102, an IP address of the UE 102, and/or other identifiers. In still other examples, packet characteristics 402 can include data encoded into the body of the data packet that can be indicative of a traffic type or application associated with the data packet.

UE characteristics 404 can include characteristics of the UE 102 and/or a subscriber profile associated with the UE 102. The UE characteristics 404 may include data indicating which frequency bands the UE 102 supports, whether the UE 102 can use licensed and/or unlicensed spectrum, whether the UE 102 supports carrier aggregation in the licensed and/or unlicensed spectrum, whether the UE 102 can use both a cellular connection and a Wi-Fi connection together, and/or other attributes of the UE 102. The UE characteristics 404 may also include information from a user account or subscriber profile associated with the UE 102, such as whether the UE 102 is associated with a first responder, is associated with a particular company or business, is associated with a certain account type or subscriber tier, and/or any other information about the subscriber or other user associated with the UE. In some examples, the UE characteristics 404 may also indicate location data associated with corresponding UEs 102. For example, a UE 102 may provide Global Positioning Satellite (GPS) coordinates or other geolocation data to the telecommunication network. In other examples, the RAN can determine, or estimate, a location of a UE 102 based on base stations to which the UE 102 is, or has, connected.

In some examples, during network registration the UE 102 may provide the telecommunication network with an International Mobile Subscriber Identity (IMSI) that uniquely identifies a subscriber associated with the UE 102, and/or an International Mobile Equipment Identity (IMEI) that uniquely identifies the UE 102. The telecommunication network may, for example, use the IMSI to retrieve a subscriber profile associated with the UE 102 and/or use the IMEI to retrieve information about capabilities of the UE 102. In other examples, the UE 102 may directly provide information to the telecommunication network, during network registration or any other point in time, that identifies which frequencies the UE 102 supports and/or other UE characteristics 404.

The network characteristics 406 can include network metrics, such as congestion levels, network utilization, latency measurements, throughput measurements, numbers of connections to base stations, and/or other types of network metrics. The network characteristics 406 may be associated with different portions of spectrum. For example, the network characteristics 406 may indicate network metrics specifically associated with one or more portions of low band, mid-band, and/or high band spectrum, such as current utilization and/or availability levels of frequencies in low bands, mid-bands, and/or high bands. The network metrics may include measurements or other metrics determined by one or more base stations, measurements or other metrics determined by one or more UEs 102 that have been reported to the base stations, and/or measurements or metrics determined by any other network element.

The network characteristics 406 can include real-time metrics reflecting a current state of one or more individual base stations, the RAN 104 overall, the core network 106, and/or other elements of the telecommunication network. The network characteristics 406 can also include historical metrics reflecting network metrics during one or more previous periods of time, average network metrics over one or more periods of time, patterns of network metrics over one or more periods of time, and/or other data associated with historical network characteristics 406. Accordingly, network characteristics 406 can reflect the network metrics at different days of the week, different times of the day, and/or at different locations. In some examples, network characteristics 406 can be filtered or indexed based on real-world events, such as concert, sporting events, traffic patterns, and/or other events that may cause large numbers of UEs 102 to gather in a geographical area. For instance, the network characteristics 406 can reflect patterns of network metrics during times when a real-world event occurred at a location and/or during times when no such real-world event was occurring.

In some examples, the network characteristics 406 can be associated with, or indexed by, QoS values, geolocation data, device types, and/or other information. For example, the network characteristics 406 can indicate utilization densities associated with QoS values 1-9 at certain geolocations. As another example, the network characteristics 406 can indicate device types of UEs 102 connected to the RAN 104 at different times and/or locations.

The flow controller 116 can use the packet characteristics 402, the UE characteristics 404, the network characteristics 406, and/or other input factors 400 to determine portions of available spectrum that base stations should use when exchanging data packets with UEs 102. For example, such input factors 400 may indicate a current state of the RAN 104 overall and/or with respect to individual geographical locations, including which types of traffic are being transported via the RAN 104, which types of UEs 102 are connected to the RAN 104, and congestions levels and other network metrics associated with different portions of spectrum. The flow controller 116 can use the state of the RAN 104 to determine that some types of traffic and/or some UEs 102 should use specific portions of spectrum, and can cause one or more base stations to use those specific portions of spectrum transporting corresponding types of traffic and/or communicating with those UEs 102.

FIG. 5 shows an example of a machine learning system 502 that can generate a spectrum allocation configuration 504 for the flow controller 116. In some examples, the machine learning system 502 can be a part of the flow controller 116 and/or execute on the same network element as the flow controller 116. In other examples, the machine learning system 502 can execute on a different server, computer, network element, or other computing device than the flow controller 116, but can provide the spectrum allocation configuration 504 to the flow controller 116. The machine learning system 502 can use one or more machine learning algorithms, such as convolutional neural networks, recurrent neural networks, other types of neural networks, nearest-neighbor algorithms, regression analysis, Gradient Boosted Machines (GBMs), Random Forest algorithms, deep learning algorithms, and/or other types of artificial intelligence or machine learning frameworks.

The machine learning system 502 can use input factors 400, including one or more of packet characteristics 402, UE characteristics 404, network characteristics 406, and/or other data to generate a spectrum allocation configuration 504. In some examples, the spectrum allocation configuration 504 can be a prediction that identifies specific portions of available spectrum that, based on a state of the RAN 104 defined by the input factors 400, are likely to permit data packets to be transmitted in accordance with at least one goal. In other examples, the spectrum allocation configuration 504 can be a configuration for the flow controller 116 that enables the flow controller 116 to use input factors 400 to determine portions of spectrum that are likely to permit data packets to be transmitted in accordance with the at least one goal. For example, the spectrum allocation configuration 504 can be weights for input factors 400, or an algorithm that includes such weights for input factors 400, that the flow controller 116 can use to determine portions of spectrum from input factors 400 and/or a state of the RAN 104.

The at least one goal can include one or more goals associated with network metrics, such as network utilization rates associated with different portions of spectrum. For example, the machine learning system 502 can use input factors 400 to determine a spectrum allocation configuration 504 that is predicted to result in the RAN 104 having at least a target minimum network utilization rate, and/or less than a target minimum network utilization rate, across one or more portions of spectrum. As a non-limiting example, the target minimum network utilization rate may be set at 70%, 75%, 80%, or other lower threshold. The target maximum network utilization rate may be set at 90%, 95%, or other upper threshold. In some cases, the upper threshold may be set at less than 100%, to maintain some available unused capacity. In this example, if network characteristics 406 indicate that 50% of mid-band frequencies are being used, and 99% of low band frequencies are being used, the machine learning system 502 may determine that usage of the mid-band frequencies is below a target minimum network utilization rate, and/or usage of the low band frequencies is above a target maximum network utilization rate. Accordingly, the machine learning system 502 can generate a spectrum allocation configuration 504 that causes some network traffic to be shifted from mid-band frequencies to the low band frequencies.

The at least one goal can also, or alternatively, include one or more goals associated with Quality of Experience (QoE) metrics, such as a target bitrate or target latency associated with a type of network traffic and/or type of UE 102. For example, packet characteristics 402 may be indicative of types of traffic, and UE characteristics 404 and/or network characteristics 406 may include measurements of bitrates, latencies, or other metrics associated with transport of data packets of those types of traffic to or from UEs 102 at different portions of spectrum. The machine learning system 502 can be configured to find a portion of spectrum that optimizes one or more QoE metrics for a type of traffic, type of UE, type of subscriber, and/or other category, such as increasing the bitrate and/or lowering the latency associated with transport of corresponding data packets. As an example, the machine learning system 502 can output a spectrum allocation configuration 504 that indicates a prediction of different ranges of spectrum that can be used to optimize QoE metrics associated different types of traffic and/or different UEs 102. For instance, the spectrum allocation configuration 504 can indicate a first portion of spectrum that is predicted to allow a first type of traffic to be transported at least at a threshold bitrate, and a second portion of spectrum that is predicted to allow a second type of traffic to be transported with a latency that is lower than an upper latency threshold.

In some examples, the machine learning system 502 can balance goals associated with network metrics and goals associated with QoE metrics. For example, the machine learning system 502 can identify which portions of spectrum, if used for certain types of traffic and/or types of UEs 102, are predicted to result in network utilization rates falling between target minimum and maximum values, and are also predicted to result in optimized QoE metrics for the types of traffic and/or types of UEs.

In some examples, the machine learning system 502 can include algorithms trained using a supervised machine learning approach. For example, a training set of data can be provided that includes input factors 400, such as packet characteristics 402, UE characteristics 404, and/or network characteristics 406 associated with a historical period of time. At least some of the input factors 400 can be “features” for machine learning algorithms. Target goals associated with network metrics, QoE metrics, and/or other goals can be established, and supervised learning algorithms can determine weights for different features and/or different combinations of features from the training set that optimize prediction of the target goals. For instance, the underlying machine learning algorithms can detect which combinations of features in the training set are statistically more relevant to predicting target goals, and/or determine weights for different features, and can thus prioritize those features in relative relation to each other. After the machine learning model 502 has been trained, the trained machine learning system 502 can be used to infer a probabilistic outcome when the trained machine learning system 502 is presented new data of the type on which it was trained.

For example, supervised machine learning techniques can be used to determine correlations and/or weightings between elements of previous packet characteristics 402, UE characteristics 404, and/or network characteristics 406 and previous results indicating network metrics and/or QoE metrics when data packets of various types were transmitted via different portions of spectrum. In various examples, such supervised machine learning can be based on recurrent neural networks or other types of neural networks, nearest-neighbor algorithms, support-vector networks, linear regression, logistic regression, other types of regression analysis, decision trees, and/or other types of artificial intelligence or machine learning frameworks. In other examples, unsupervised machine learning techniques can be used to derive correlations and/or relationships between input factors 400 and portions of spectrum.

In some examples, after the machine learning system 502 has been trained on a set of previous training data, the machine learning system 502 can use new input factors 400 reflecting a current network state, including new packet characteristics 402, UE characteristics 404, and/or network characteristics 406, to generate a new spectrum allocation configuration 504. The spectrum allocation configuration 504 can be a prediction of which portions of spectrum should be used for one or more types of traffic and/or one or more UEs 102. The spectrum allocation configuration 504 can be provided to the flow controller 116, and the flow controller 116 can use the spectrum allocation configuration 504 to cause the RAN 104 to use the predicted portions of spectrum to transport corresponding data packets. For example, the flow controller 116 can use the spectrum allocation configuration 504 to allocate or reserve portions of spectrum that correspond to traffic types and/or UE types in the spectrum allocation configuration 504.

In other examples, after the machine learning system 502 has been trained on a set of previous training data, the spectrum allocation configuration 504 can be a copy of an underlying trained machine learning algorithm. For example, the spectrum allocation configuration 504 can include an algorithm with weights for different input factors 400 that have been determined via the training of the machine learning system 502. The trained algorithm can be provided to the flow controller 116 as a spectrum allocation configuration 504, such that the flow controller 116 can use the spectrum allocation configuration 504 to itself determine portions of spectrum that correspond to traffic types and/or UE types, and allocate or reserve those portions of spectrum for the traffic types and/or UE types.

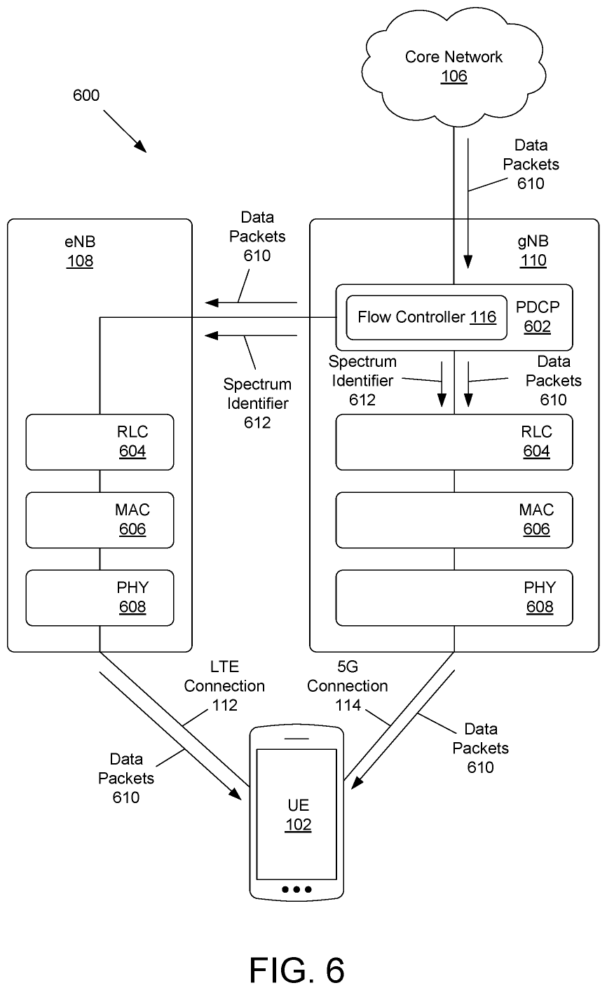

FIG. 6 shows an example 600 of data packets 610 passing through protocol layers in the eNB 108 and the gNB 110. Downlink data can pass through multiple layers of a protocol stack in the eNB 108 and/or the gNB 110 before being transmitted to the UE 102. Each layer may process data received from a previous layer, for instance by adding its own header or performing any other operation on the data, and can then pass the data to the next layer. When a data packet 610 is received at the UE 102, corresponding layers at the UE 102 can reverse the operations performed by layers in the eNB 108 or the gNB 110 to find or reconstruct the data that was originally sent by the core network 106.

The layers in the protocol stack can include a PDCP layer 602, a Radio Link Control (RLC) layer 604, a Media Access Control (MAC) layer 606, and/or a physical (PHY) layer 608. In some examples, a SDAP layer may be present above the PDCP layer 602. For instance, in some examples the gNB 110 may have an SDAP layer above the PDCP layer 602.

As shown in FIG. 6, the PDCP layer 602 can receive data packets 610, such as IP packets for user plane data, from the core network 106. In some examples, the PDCP layer 602 can receive the data packets 610 within service data units (SDUs) output by an upper SDAP layer. The PDCP layer 602 can operate on the data packets 610 and output protocol data units (PDUs) that include one or more portions the data packets 610 on to the next layer of the protocol stack, such as the RLC layer 604. For example, the PDCP layer 602 can perform one or more operations on data packets 610, such as adding a PDCP header or performing header compression, ciphering, and/or integrity protection, and output the data packets 610 as PDUs to the RLC layer 604.

In some examples, the PDCP layer 602 at the gNB 110 can be where a split bearer divides into an LTE leg and a 5G leg, or otherwise be where the gNB 110 can route data packets 610 over one or both of the LTE connection 112 and the 5G connection 114. The flow controller 116 described herein can execute on the gNB 110 at the PDCP layer 602 to group, aggregate, and/or divide data packets 610 received from the core network 106 into sets of data packets 610 associated with the LTE connection 112 and/or the 5G connection 114. In some examples, aggregation of data packets 610 at the PDCP layer 602 into data packets 610 for different legs of a split bearer can be referred to as “downlink PDCP aggregation.”

In some examples, the flow controller 116 may cause some of the data packets 610 to be routed via the LTE connection 112. For example, the flow controller 116 can cause data packets 610 to be sent from the gNB 110 to the eNB 108 via an X2 interface or other interface. In some examples, because such data packets 610 have already been processed at the PDCP layer 602 of the gNB 110, the data packets 610 can be passed directly to the RLC layer 604 of the eNB 108. In other examples, the eNB 108 may pass the data packets 610 through a PDCP layer 602 of the eNB 108 to the RLC layer 604 of the eNB 108. The flow controller 116 may also cause some of the data packets 610 to be routed via the 5G connection 114, for instance by passing data packets 610 from the PDCP layer 602 to the RLC layer 604 within the gNB 110.

An RLC layer 604 at the eNB 108 can receive data packets 610 output by the PDCP layer 602 of the gNB 110, while a similar RLC layer 604 at the gNB 110 can receive data packets 610 output by the PDCP layer 602 of the gNB 110. The respective RLC layers 604 at the eNB 108 and the gNB 110 can perform operations on the received data, including error detection, segmentation, re-segmentation, or other operations. Each RLC layer 604 can pass its output to a MAC layer 606, which can perform other operations including error correction, scheduling, or prioritization. Each MAC layer 606 can similarly pass its output to a PHY layer 608, where the data can be transmitted to the UE 102 over an air interface associated with the LTE connection 112 or the 5G connection 114. The RLC layer 604, the MAC layer 606, and/or the PHY layer 608 may each process or encapsulate data received from upper layers into its own output. The UE 102 can accordingly process received data at a PHY layer 608 of the UE 102, a MAC layer 606 of the UE 102, and an RLC layer 604 of the UE 102 to find or reconstruct the data packets 610. The UE 102 can also process the data packets 610 at a PDCP layer 602 of the UE 102 to reconstruct the data packets 610 originally sent by the core network 106.

As discussed above, the flow controller 116 can operate at the PDCP layer 602 to determine portions of spectrum to use to transmit the data packets 610. For example, the flow controller 116 can use packet characteristics 402 of a data packet 610, UE characteristics 404 of the UE 102, network characteristics 406, and/or other data to determine a corresponding portion of spectrum to use when transmitting the data packet 610 to the UE 102. In some examples, the flow controller 116 can use a spectrum allocation configuration 504 generated by the machine learning system 502 to determine the portions of spectrums to use to transmit the data packets 610. The flow controller 116 can output a spectrum identifier 612 that indicates the determined portion of spectrum for the data packet 610. In some examples, the flow controller 116 can mark, or otherwise modify the data packet 610 to include the spectrum identifier 612. In other examples, the flow controller 116 can output the spectrum identifier 612 as a separate indication or instruction associated with the data packet 610. For example, the spectrum identifier 612 can be an instruction that can be read by a scheduler at the MAC layer 606 or by the PHY layer 608 that indicates which portion of spectrum to use when sending the data packet 610.

Although FIG. 6 shows the flow controller 116 located at the PDCP layer 602 of the gNB 110, in other examples the flow controller 116 can be located at the PDCP layer 602 of the eNB 108. For instance, when the flow controller 116 is located at the PDCP layer 602 of the eNB 108, the flow controller 116 can similarly group, aggregate, and/or divide data packets 610 received from the core network 106. The flow controller 116 at the PDCP layer 602 of the eNB 108 can also determine portions of spectrum to use to transmit data packets 610 as described herein, and can output spectrum identifiers 612 that indicates the determined portions of spectrum for the data packets 610. In some examples, the flow controller 116 can use a spectrum allocation configuration 504 generated by the machine learning system 502 to determine the portions of spectrums to use to transmit the data packets 610. The flow controller 116 at the PDCP layer 602 of the eNB 108 can route data packets 610 to the RLC layer 604 within the eNB 108, and can route data packets 610 to the gNB 110 via an X2 interface or other interface. Subsequent RLC layers 604, MAC layers 606, and PHY layers 608 in the eNB 108 and the gNB 110 can then further operate on the data packets 610. For example, spectrum identifiers 612 output by the flow controller 116 can indicate which portions of spectrum the eNB 108 and gNB 110 are to use when transmitting the data packets 610 to the UE 102 via the LTE connection 112 and the 5G connection 114.

In still other examples, the flow controller 116 can be located at a PDCP layer 602 of another network element, such as a base station hotel, a neural host location, a mobile switching office, or other network element as shown in FIG. 3. In these examples, the flow controller 116 can analyze data packets 610 at a PDCP layer 602 to determine portions of spectrum that base stations should use to transmit the data packets 610. In some examples, the flow controller 116 can use a spectrum allocation configuration 504 generated by the machine learning system 502 to determine the portions of spectrums to use to transmit the data packets 610. The flow controller 116 can thus output corresponding spectrum identifiers 612 that instruct base stations, such as the eNB 108 and/or the gNB 110, which portions of spectrum to use when transmitting the data packets 610 to UEs 102.

FIG. 7 shows a first example table 700 of traffic types 702 that correspond to spectrum ranges 704. The flow controller 116 can use packet characteristics 402, such DSCP markings, QoS values, QoS flow identifiers, and/or other data to determine traffic types 702 associated with data packets 410. For example, certain packet characteristics 402 may be indicative of cloud gaming, real-time communications, media streaming, and/or other types of network traffic. In some examples, the flow controller 116 can use a spectrum allocation configuration 504 generated by the machine learning system 502 to determine the portions of spectrums to use to transmit the data packets 610.

As shown in FIG. 7, the flow controller 116 may determine that some traffic types 702 should be associated with corresponding spectrum ranges 704. In some examples, spectrum ranges 704 that correspond to the traffic types 702 may be at least partially determined based on UE characteristics 404, network characteristics 406, and/or other data. For example, the machine learning system 502 can have determined the table 700, or any other indication of traffic types 702 that correspond to spectrum ranges 704, as a spectrum allocation configuration 504 based on a training set of packet characteristics, UE characteristics 404, and/or network characteristics 406.

As a non-limiting example, the flow controller 116 may determine that certain packet characteristics 402 indicate that data packets are associated with cloud gaming services. Cloud gaming services may render images on backend servers, and use data packets to transmit the rendered images to UEs 102. The cloud gaming services can thus be associated with a target low-latency QoE goal, such that the rendered images are delivered quickly enough to a UE 102 to avoid a perception of lag between user input commands and display of the rendered images on the UE 102 in response. In this situation, the flow controller 116 can identify a certain spectrum range 704A that may likely allow the cloud gaming data packets to be delivered to UEs 102 with a latency that meets the target low-latency QoE goal. The flow controller 116 can thus reserve the identified spectrum range 704A in association with cloud gaming services, and cause the RAN 104 to use the reserved spectrum range 704A for connections with UEs 102 that are associated with transmission of cloud gaming packets. In this situation, the RAN 104 and UEs 102 can use other portions of spectrum, different from spectrum range 704A, to transmit other types of data packets.

In some examples, the flow controller 116 can reserve and/or allocate multiple specific spectrum ranges 704 for corresponding traffic types 702. For example, the flow controller 116 can reserve the spectrum range 704A for cloud gaming traffic, a spectrum range 704B for real-time communications, a spectrum range 704C for media streaming traffic, and/or other spectrum ranges 704 for other types of traffic. In some examples, the spectrum ranges 704 may be in the licensed spectrum used by the RAN 104. However, in other examples, the flow controller 116 may cause the telecommunication network to bid on at least temporarily use of CBRS spectrum or other unlicensed spectrum, and allocate one or more spectrum ranges 704 in the unlicensed spectrum to traffic types if and when use of the unlicensed spectrum is granted.

In some examples, when the flow controller 116 allocates different spectrum ranges 704 to different traffic types 702 as shown in FIG. 4, base stations may use different component carriers to transmit data packets of the different traffic types 702 to the same UE 102. For example, if a UE 102 is engaged in a cloud gaming session and a real-time communication session, carrier aggregation can be used to establish a first component carrier for the UE at a first frequency in the first spectrum range 704A to transport the cloud gaming traffic, and to establish a second component carrier for the UE 102 at a second frequency in the second spectrum range 704B to transport the real-time communication traffic.

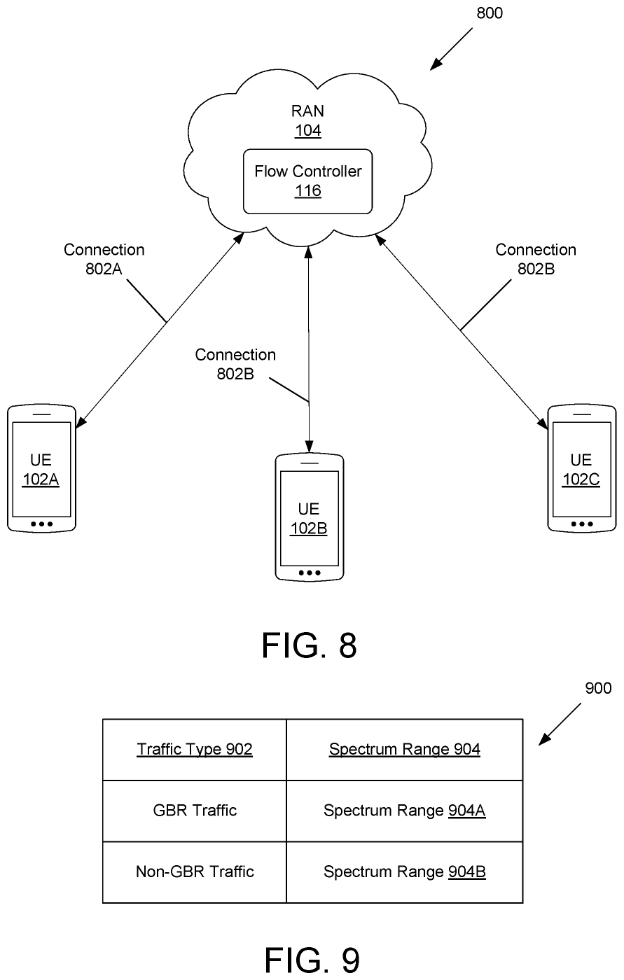

Although in some examples the flow controller 116 can allocate and/or reserve different spectrum ranges 704 for different traffic types 702 as shown in FIG. 7, in other examples the flow controller 116 can also, or alternately, allocate and/or reserve different spectrum ranges 704 for different UEs 102 and/or different types of UEs 102. For example, FIG. 8 shows a network environment 800 in which the RAN 104 is connected to a first UE 102A via a first connection 802A, to a second UE 102B via a second connection 802B, and to a third UE 102C via a third connection 802C. In some examples, the first connection 802A, the second connection 802B, and/or the third connection 802C may each include one or more connections to base stations. For instance, the first connection 802A may be an EN-DC connection between the first UE 102A and both the eNB 108 and the gNB 110. In this example, the flow controller 116 may determine that communications with the first UE 102A via the first connection 802A should use a different portion of spectrum than communications with the second UE 102B and/or the third UE 102C.

As a non-limiting example, the flow controller 116 may determine that data packets for the first UE 102A are associated with emergency traffic, such as traffic associated with first responders. For instance, certain DSCP markings, QoS values, or other packet characteristics 402 may be indicative of emergency traffic. As another example, the flow controller 116 may use a subscriber profile or other UE characteristics 404 to determine that that the first UE 102A is associated with a first responder and thus is also associated with emergency traffic. The flow controller 116 may use similar packet characteristics 402 and/or UE characteristics 404 associated with the second UE 102B and the third UE 102C to determine that the second UE 102B and the third UE 102C are not associated with emergency traffic.

In this example, the flow controller 116 may be configured to prioritize the emergency traffic by reserving a portion of low band spectrum for the emergency traffic, for instance during emergency situations in which emergency traffic is being transported through the RAN 104 or when at least at threshold number of data packets associated with emergency traffic is detected by the flow controller 116. For example, the machine learning system 502 may have determined that the portion of the low band spectrum offers at least a threshold level of reliability for emergency traffic during previous situations associated with similar packet characteristics 402, UE characteristics 404, and/or network characteristics 406. The flow controller 116 can allocate at least the portion of the low band spectrum to emergency traffic, and cause the RAN 104 to use the allocated portion of the low band spectrum for the first connection 802A. The flow controller 116 can also cause the RAN 104 to use other spectrum for the second connection 802B and the third connection 802C, for example by pushing the second connection 802B and the third connection 802C to use mid-band spectrum or high band spectrum.

Accordingly, during an emergency situation in which the flow controller 116 detects emergency traffic passing through the RAN 104, use of the reserved portion of the low band spectrum can be limited to the first UE 102A and/or other UEs 102 associated with emergency traffic. This can lower congestion in the reserved portion of the low band spectrum, and thereby improve reliability of the emergency traffic. Other UEs, such as UE 102B and UE 102C, may still send and receive data packets via other portions of spectrum that are not reserved for emergency traffic. In some examples, when the emergency situation is resolved, the flow controller 116 may end the limitations on use of the reserved portion of the low band spectrum, and again permit any UE 102 to use any available spectrum. For example, if the number of data packets associated with emergency traffic passing through the flow controller 116 drops below a predefined threshold, or such emergency traffic data packets are not observed by the flow controller 116 for more than a threshold period of time, the flow controller 116 may determine that the emergency situation is over, and free up the reserved spectrum for use by any UE 102.

FIG. 9 shows a second example table 900 of traffic types 902 that correspond to spectrum ranges 904. The flow controller 116 can use packet characteristics 402, such DSCP markings, QoS values, QoS flow identifiers, and/or other data to determine whether data packets are associated with traffic types 902 such as GBR traffic or non-GBR traffic. For example, as discussed above, QoS values 1-4 may be indicative of GBR traffic, while QoS values 5-9 may be indicative of non-GBR traffic.

In some examples, the flow controller 116 can associate GBR traffic with a first spectrum range 904A, and/or can associate non-GBR traffic with a second spectrum range 904B. For example, the machine learning system 502 may have determined that the first spectrum range 904A is predicted to allow GBR traffic to be transmitted at least at a bitrate sufficient to meet a guaranteed bitrate goal, based on previous situations associated with similar packet characteristics 402, UE characteristics 404, and/or network characteristics 406. For instance, the machine learning system 502 may have determined that the first spectrum range 904A is predicted to permit a base station and a UE 102 to transfer data at a bitrate that exceeds the guaranteed bitrate goal, based at least in part on input factors 400 such as a location of the UE 102 with respect to the base station.

Accordingly, the flow controller 116 can reserve the identified first spectrum range 904A in association with GBR traffic, and cause the RAN 104 to use the reserved first spectrum range 904A to transmit data packets with packet characteristics that are indicative of GBR traffic. As an example, the base station can establish a dedicated bearer with the UE 102 using frequencies in the first spectrum range 904A, which can be used to transport any data packets that have QoS values of 1-4 and are thus indicative of GBR traffic. Accordingly, in this example, a single bearer channel established in the spectrum range 904A can be used to carry traffic for multiple GBR QoS values. In this example, the RAN 104 and the UE 102, or other UEs 102, can exchange non-GBR data packets using other portions of spectrum, such as the spectrum range 904B or any other portion of spectrum that has not been reserved for GBR traffic.

In some examples, the flow controller 116 and/or the machine learning system 502 may determine a spectrum allocation associated with a GBR bearer based on correlating or otherwise analyzing a set of factors associated with GBR traffic. For example, the flow controller 116 may determine that at least a threshold number of UEs 102 are connected to the RAN 104 are associated with traffic of QoS values 1-4, consider geolocation data associated with the network traffic, and allocate spectrum for a GBR bearer for QoS values 1-4 at a certain location.

### Example Architecture

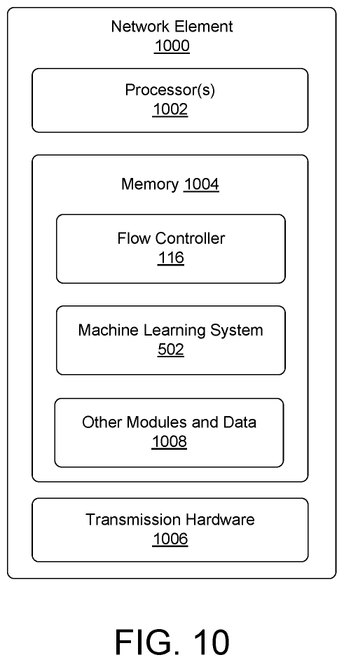

FIG. 10 shows an example system architecture for a network element 1000 configured to execute the flow controller 116, in accordance with various examples. In various examples, the network element 1000 can be the eNB 108, the gNB 110, a base station hotel, a neural host location, a mobile switching office, a server or other computing device that executes elements of a virtual RAN, or any other element of the telecommunication network that can indicate a spectrum range to use when transmitting data packets to the UE 102 over a wireless connection, such as the LTE connection 112 or the 5G connection 114. As shown, the network element 1000 can include processor(s) 1002, memory 1004, and transmission hardware 1006. The memory 1004 can store computer-readable instructions and/or other data associated with the flow controller 116, the machine learning system 502, and other module and data 1008.

In various examples, the processor(s) 1002 can be a central processing unit (CPU), a graphics processing unit (GPU), both CPU and GPU, or any other type of processing unit. Each of the one or more processor(s) 1002 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 1002 may also be responsible for executing all computer applications stored in the memory 1004, which can be associated with types of volatile (RAM) and/or nonvolatile (ROM) memory.

In various examples, memory 1004 can include system memory, which may be volatile (such as RAM), non-volatile (such as ROM, flash memory, etc.) or some combination of the two. The memory 1004 can also include additional data storage devices (removable and/or non-removable) such as, for example, magnetic disks, optical disks, or tape. Memory 1004 can further include non-transitory computer-readable media, such as volatile and nonvolatile, removable and non-removable media implemented in any method or technology for storage of information, such as computer-readable instructions, data structures, program modules, or other data. For example, the memory 1004 can store software or firmware elements, such as computer-readable instructions that are executable by the one or more processors 1002. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information and which can be accessed by the network element 1000. Any such non-transitory computer-readable media may be part of the network element 1000.

The transmission hardware 1006 can include one or more modems, receivers, transmitters, antennas, error correction units, symbol coders and decoders, processors, chips, application specific integrated circuits (ASICs), programmable circuit (e.g., field programmable gate arrays), firmware components, and/or other components that can establish connections with one or more UEs 102, one or more base stations, and/or the core network 106, and transmit data over such connections. For example, when the network element 1000 is the gNB 110, the transmission hardware 1006 can establish the 5G connection 114 with the UE 102 over an air interface, a connection with the eNB 108 over an X2 interface, and a connection with the core network 106 over an SI interface. The transmission hardware 1006 can also support transmissions using one or more radio access technologies, such as 5G NR or LTE, as discussed above.

The transmission hardware 1006 can also be configured to apply or otherwise implement spectrum identifiers 612 generated by the flow controller 116 that indicate portions of spectrum to use for certain types of traffic and/or certain UEs 102. For example, if the flow controller 116 generates a spectrum identifier 612 indicating that a base station should use a certain portion of spectrum to transport a certain type of network traffic, the transmission hardware 1006 can follow the spectrum identifier 612 and use the indicated portion of spectrum when sending and/or receiving corresponding data packets via an LTE connection 112, 5G connection 114, or other connection with a UE 102.

As discussed above, the flow controller 116 can allocate and/or reserve portions of spectrum in the RAN 104 for different types of traffic and/or different UEs 102. The flow controller 116 can be configured to use input factors 400, such as packet characteristics 402, UE characteristics 404, network characteristics 406, and/or other input factors 400 to determine the portions of spectrum to reserve and/or allocate. In some examples, the flow controller 116 can use a spectrum allocation configuration 504 generated by the machine learning system 502 to determine the portions of spectrum to reserve and/or allocate.

As discussed above, the machine learning system 502 can be trained on a training set of input factors 400, such as such as packet characteristics 402, UE characteristics 404, network characteristics 406, and/or other input factors 400, such that the machine learning system 502 can use new input factors 400 to generate a spectrum allocation configuration 504 for the flow controller 116. In some examples, the machine learning system 502 may execute on the same network element 1000 as the flow controller 116. In other examples, the machine learning system 502 may be stored on and/or execute at, a different network element 1000 than the flow controller 116, which can transmit the spectrum allocation configuration 504 to the network element 1000 that executes the flow controller 116.

The other modules and data 1008 stored in the memory 1004 can be utilized by the network element 1000 to perform or enable performing any action taken by the network element 1000. The modules and data 1008 can include a platform, operating system, firmware, and/or applications, and data utilized by the platform, operating system, firmware, and/or applications.

### Example Operations

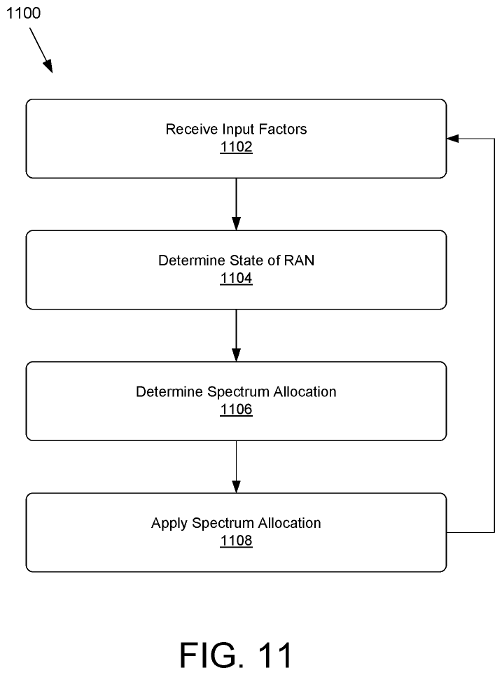

FIG. 11 shows a flowchart of an example method 1100 that a flow controller 116 can use to determine a spectrum allocation based on input factors 400 associated with a state of the RAN 104. As discussed above, the flow controller 116 may execute at a base station as shown in FIG. 1, or outside a base station as shown in FIG. 3.

At block 1102, the flow controller 116 can receive input factors 400. The input factors 400 can include packet characteristics 402 associated with data packets that are currently being routed through the RAN 104 and/or passed through the flow controller 116. The input factors 400 can also include UE characteristics 404 associated with one or more UEs 102, such as UEs 102 that are connected to one or more base stations of the RAN 104. The input factors 400 can also include network characteristics 406, such as congestion levels, network utilization, latency measurements, throughput measurements, numbers of connections to base stations, and/or other types of network metrics associated with different portions of spectrum.

At block 1104, the flow controller 116 can determine a state of the RAN 104 based on the input factors received at block 1102. For example, the flow controller 116 can use packet characteristics 402 to determine traffic types currently being routed through the RAN 104. The flow controller 116 can also use UE characteristics 404 to determine UE types or capabilities, and/or subscriber information, associated with UEs 102 that are connected to the RAN 104. The flow controller 116 can further use network characteristics 406 to determine current network metrics associated with the RAN 104.

At block 1106, the flow controller 116 can determine a spectrum allocation for the RAN 104, based on the state of the RAN 104 determined at block 1104. For example, if the state of the RAN 104 indicates that one or more certain types of traffic are being transported via the RAN 104, the flow controller 116 can identify corresponding portions of spectrum to allocate to transport those types of traffic. As described above, in some examples the flow controller 116 can have, or use, a machine learning system 502 to determine a spectrum allocation configuration 504, based on the input factors 400 that indicate the state of the RAN 104. Such a spectrum allocation configuration 504 can be the spectrum allocation determined at block 1106. In other examples, the flow controller 116 can be configured with an algorithm determined by the machine learning system 502, such that the flow controller 116 can use the algorithm to determine a spectrum allocation for the RAN 104 based on the input factors 400 that define the state of the RAN 104.

At block 1108, the flow controller 116 can apply the spectrum allocation by causing one or more base stations to use the allocated portions of spectrum to transport data packets to one or more UEs 102. As an example, when the flow controller 116 executes in a gNB 110 as shown in FIG. 6, the flow controller can provide spectrum identifiers 612 to other layers in the gNB 110 and in an eNB 108, such that the flow controller 116 can allocate spectrum with respect to both the gNB 110 and the eNB 108. As another example, when the flow controller 116 at a network element outside a base station as shown in FIG. 3, the flow controller 116 can transmit spectrum identifiers 612 to one or more base stations in the RAN 104 to allocate spectrum with respect to the base stations.

After determining and applying a spectrum allocation at block 1106 and 1108, the flow controller 116 can receive new input factors 400 at block 1102 that may reflect a new or changed state of the RAN 104. For example, the types of traffic being transported through the RAN 104 may have changed, the number or types of UEs 102 connected to the RAN 104 may have changed, and/or network metrics may have changed. For instance, the network metrics may have changed as a result of the previous spectrum allocation determined by the flow controller 116. Accordingly, as the state of the RAN 104 changes, the flow controller 116 can dynamically, in real-time or near real-time, adjust the spectrum allocation used in the RAN 104.

In some examples, the flow controller 116 can use the operations show in FIG. 11 to determine a state of the RAN 104 with respect to a particular geographical area, and to determine and apply a spectrum allocation associated with that particular geographical area. For example, the flow controller 116 can determine a state of the RAN 104 associated with a single base station or a set of base stations in a cell, neighborhood, town, or other geographical area. Based on the current state of the RAN 104, the flow controller 116 can determine a spectrum allocation to be used by one or more of the base stations in the geographical area when communicating with one or more UEs in the geographical area. As an example, when the flow controller 116 executes in a gNB 110 as shown in FIG. 6, the flow controller 116 can provide spectrum identifiers 612 to other layers in the gNB 110 and in a nearby eNB 108, such that the flow controller 116 can allocate spectrum within the geographical area associated with both the gNB 110 and the eNB 108. As another example, when the flow controller 116 executes outside a base station as shown in FIG. 3, the flow controller 116 can allocate spectrum with respect to a geographical area, and thus cause a set of base stations in that geographical area to use the allocated spectrum.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A method, comprising:
receiving, by a flow controller executing at a network element of a telecommunication network, one or more input factors associated with a radio access network (RAN);
determining, by the flow controller, a state of the RAN based on the input factors;
determining, by the flow controller, a spectrum allocation that indicates one or more portions of spectrum associated with at least one of:
one or more traffic types, or
one or more user equipment (UE) types; and
causing, by the flow controller, one or more base stations of the RAN to use the one or more portions of spectrum indicated by the spectrum allocation during communications with one or more UEs that are associated with the one or more traffic types or the one or more UE types.

2. The method of claim 1, wherein the input factors include one or more of:
packet characteristics associated with data packets passing through the flow controller;
UE characteristics associated with the one or more UEs; or
network characteristics associated with the RAN.

3. The method of claim 1, wherein the one or more portions of spectrum are selected from one or more of low band frequencies, mid-band frequencies, or high band frequencies.

4. The method of claim 1, wherein the spectrum allocation indicates a first portion of spectrum associated with a first type of traffic and a second portion of spectrum associated with a second type of traffic.

5. The method of claim 1, wherein the spectrum allocation indicates at least a first portion of spectrum associated with guaranteed bitrate traffic.

6. The method of claim 1, wherein the flow controller generates the spectrum allocation based at least in part on a machine learning system trained based on historical data associated with the input factors.

7. The method of claim 1, wherein the one or more base stations include one or more of a Long-Term Evolution (LTE) base station and a fifth generation (5G) base station.

8. The method of claim 1, wherein the network element at which the flow controller executes is one of the one or more base stations.

9. The method of claim 1, wherein the network element at which the flow controller executes is positioned between a core network of the telecommunication network and the one or more base stations.

10. The method of claim 1, wherein the flow controller executes at a Packet Data Convergence Protocol (PDCP) layer in the network element.

11. A network element, comprising:
one or more processors;
memory storing computer-executable instructions that, when executed by the one or more processors, cause a flow controller of the network element to perform operations comprising:
receiving one or more input factors associated with a radio access network (RAN);
determining a state of the RAN based on the input factors;
determining a spectrum allocation that indicates one or more portions of spectrum associated with at least one of:
one or more traffic types, or
one or more user equipment (UE) types; and
causing one or more base stations of the RAN to use the one or more portions of spectrum indicated by the spectrum allocation during communications with one or more UEs that are associated with the one or more traffic types or the one or more UE types.

12. The network element of claim 11, wherein the input factors include one or more of:
packet characteristics associated with data packets passing through the flow controller;
UE characteristics associated with the one or more UEs; or
network characteristics associated with the RAN.

13. The network element of claim 11, wherein the spectrum allocation indicates a first portion of spectrum associated with a first type of traffic and a second portion of spectrum associated with a second type of traffic.

14. The network element of claim 11, wherein the spectrum allocation indicates at least a first portion of spectrum associated with guaranteed bitrate traffic.

15. The network element of claim 11, wherein the flow controller generates the spectrum allocation based at least in part on a machine learning system trained based on historical data associated with the input factors.

16. One or more non-transitory computer-readable media storing computer-executable instructions that, when executed by one or more processors of a network element, cause a flow controller of the network element to perform operations comprising:
receiving one or more input factors associated with a radio access network (RAN);
determining a state of the RAN based on the input factors;
determining a spectrum allocation that indicates one or more portions of spectrum associated with at least one of:
one or more traffic types, or
one or more user equipment (UE) types; and
causing one or more base stations of the RAN to use the one or more portions of spectrum indicated by the spectrum allocation during communications with one or more UEs that are associated with the one or more traffic types or the one or more UE types.

17. The one or more non-transitory computer-readable media of claim 16, wherein the input factors include one or more of:
packet characteristics associated with data packets passing through the flow controller;
UE characteristics associated with the one or more UEs; or
network characteristics associated with the RAN.

18. The one or more non-transitory computer-readable media of claim 16, wherein the spectrum allocation indicates a first portion of spectrum associated with a first type of traffic and a second portion of spectrum associated with a second type of traffic.

19. The one or more non-transitory computer-readable media of claim 16, wherein the spectrum allocation indicates at least a first portion of spectrum associated with guaranteed bitrate traffic.

20. The one or more non-transitory computer-readable media of claim 16, wherein the flow controller generates the spectrum allocation based at least in part on a machine learning system trained based on historical data associated with the input factors.
